(19) United States
(12) Patent Application Publication
(10) Pub. No.: US 2010/0009188 A1
(43) Pub. Date: Jan. 14, 2010

(54) NANO-STRUCTURED SURFACE AND AN IN SITU METHOD FOR FORMING THE SAME

(76) Inventors: John Haozhong Xin, Hong Kong (HK); Yu Yang Liu, Hong Kong (HK); Hai Feng Lu, Hong Kong (HK); Xian Qiong Chen, Hong Kong (HK)

Correspondence Address: EVAN LAW GROUP LLC, 600 WEST JACKSON BLVD., SUITE 625, CHICAGO, IL, 60661, US

(21) Appl. No.: 12/172,004

(22) Filed: Jul. 11, 2008

(51) Int. Cl. B32B 5/16; B05D 3/02

(52) U.S. Cl. 428/402; 427/397.7

(57) ABSTRACT

A nano-structured surface includes a substrate layer, and a plurality of immobilized nanoparticles on the substrate layer. The surface has a water contact angle of greater than 145 degrees. An in situ method of fabricating a nano-structured surface includes treating a substrate layer with a mixture that includes a silica precursor, a water-soluble catalyst, and a low-surface-energy compound to form a treated substrate layer, and curing said treated substrate layer in the atmosphere of ammonia to form a nano-structured surface on the substrate layer.

### BACKGROUND

Solid substrates with superior hydrophobic surfaces may find wide applications in the industries, and great economic interests exist in manufacturing surfaces with self-cleaning or repellent properties.

Traditional hydrophobic materials have water contact angles of up to about 120 degrees. One technique for the fabrication of hydrophobic surfaces on solid substrates includes creating a rough surface, such as a surface with a fractal structure. Another technique for the fabrication of hydrophobic surfaces on solid substrates includes modifying the surface with materials of low surface free energy, such as fluorinated or silicon-containing compounds. A drawback to these techniques is that special equipment and/or complex process control is typically required.

In one example, U.S. Pat. No. 3,354,022 discloses water repellent surfaces on a hydrophobic material, where the surfaces have a rough micro-structure with elevations and depressions. A self-cleaning effect may be obtained for ceramic bricks or glass by coating the substrate with a suspension containing glass spheres with a diameter of approximately 3 to 12 μm, and a fluorocarbon wax based on a fluoroalkylethoxy methacrylate polymer. These coatings, however, have poor resistance to abrasion, with only a moderate self-cleaning effect.

In another example, European patent nos. EP 0772514B1 and EP 0933388 A2 disclose self-cleaning surfaces on articles with an artificial surface structure that includes elevations and depressions. The height differences between the elevations and the depressions are from 5 to 200 μm. The distances between the elevations are from 50 nm to 10 μm. The structures are made of hydrophobic polymers. The process of making these surfaces is expensive, and the surfaces formed have little resistance to abrasion. Thus, the self-cleaning effect declines rapidly if strong mechanical stress is applied.

In a further example, European patent no. EP 0909747A1 discloses a surface that has hydrophobic elevations having a height of around 5 to 200 μm. Such a surface is produced by applying a dispersion of powder particles of an inert material in a siloxane solution, and subsequently curing the siloxane solution to form a polysiloxane. However, the particle structure formed is not well fixed to the surface of the substrate in an abrasion stable manner. Thus, the abrasion resistance is undesirably low.

Consequently, it is desirable to produce a nano-structured surface that has a large water contact angle and a great self-cleaning effect. It is also desirable to develop an inexpensive fabrication method of making such a nano-structured surface.

### BRIEF SUMMARY

According to one aspect, a nano-structured surface includes a substrate layer, and a plurality of immobilized nanoparticles on the substrate layer. The surface has a water contact angle of greater than 145 degrees.

According to another aspect, an in situ method of fabricating a nano-structured surface includes treating a substrate layer with a mixture that includes a silica precursor, a water-soluble catalyst, and a low-surface-energy compound to form a treated substrate layer, and curing said treated substrate layer in an atmosphere that includes ammonia to form a nano-structured surface on said substrate layer.

### BRIEF DESCRIPTION OF THE DRAWINGS

FIG. 1 depicts a scanning electron microscope photograph of a self-cleaning surface on a cotton fabric substrate.

FIG. 2 depicts an optical image of a water droplet, for measuring the water contact angle, on the self-cleaning surface of FIG. 1.

### DETAILED DESCRIPTION

Reference will now be made in detail to a particular embodiment of the invention, examples of which are also provided in the following description. Exemplary embodiments of the invention are described in detail, although it will be apparent to those skilled in the relevant art that some features that are not particularly important to an understanding of the invention may not be shown for the sake of clarity.

Furthermore, it should be understood that the invention is not limited to the precise embodiments described below, and that various changes and modifications thereof may be effected by one skilled in the art without departing from the spirit or scope of the invention. For example, elements and/or features of different illustrative embodiments may be combined with each other and/or substituted for each other within the scope of this disclosure and appended claims. In addition, improvements and modifications which may become apparent to persons of ordinary skill in the art after reading this disclosure, the drawings, and the appended claims are deemed within the spirit and scope of the present invention.

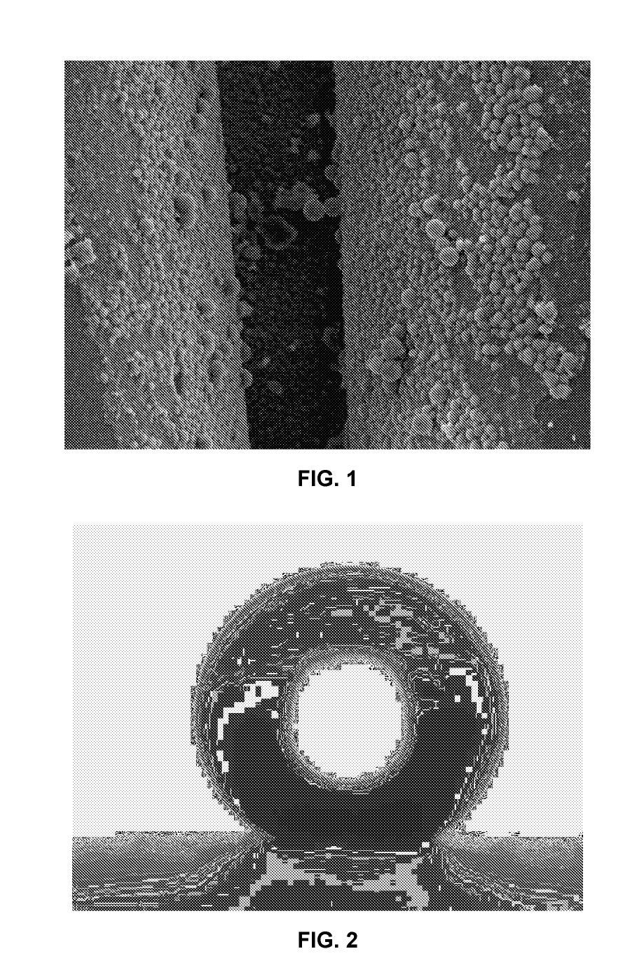

A nano-structured surface includes a substrate layer, and a plurality of immobilized nanoparticles on the substrate layer. The surface has a water contact angle of greater than 145 degrees. An example of such a nano-structured surface is depicted in FIG. 1. For example, the nanoparticles may be silica nanoparticles. Examples of the substrate layer may include fabric, leather, wood, glass, ceramic, concrete, plastic, metal, brick, and combinations thereof. Fabric substrates may include cellulosic fibres, such as cotton, linen, or viscose; protein fibres, such as wool, silk, or other animal hair; synthetic fibres such as polyester, polyamide, or polypropylene; or combinations of these fibres.

A large water contact angle is indicative of a surface that has low surface energy. Low surface energy is an important factor for an effective self-cleaning surface. When the surface energy is lowered, the hydrophobicity is enhanced. The term “self-cleaning” is defined to mean a surface that is virtually unwettable by water, and preferably by other liquids. When a liquid is contacted with a self-cleaning surface, rapid drop formation may occur, and dirt particles may be washed away in the same manner as when water drops run down the surface. Therefore, a substrate with a self-cleaning surface is substantially dry when water has run off the surface.

The self-cleaning, or repellency, effect on the substrate result at least in part from a nano-scale surface roughness, which is a structure with assembled or immobilized nanoparticles on the surface in a geometrical or random arrangement. This nano-scale surface roughness may be distributed over the entire surface. For example, the nanoparticles may be silica nanoparticles with a mean diameter from about 50 to 1000 nm, and preferably from about 50 to 500 nm. The surface may endow the solid substrate with superior hydrophobic properties and with higher water contact angles, resulting in an artificial lotus-leaf surface on the solid substrate.

There is also provided an in situ method of fabricating a nano-structured surface that includes treating a substrate layer with a mixture that includes a silica precursor, a water-soluble catalyst, and a low-surface-energy compound, to form a treated substrate layer; and curing the treated substrate layer in an atmosphere of ammonia to form a nano-structured surface on the substrate layer. For example, the treated substrate may be cured at a temperature of from 60° C. to 180° C., or preferably of from 60° C. to 120° C.

Examples of silica precursors include methyltrimethoxysilane, methyltriethoxysilane, vinyltrimethoxysilicane, tetramethoxysilane, tetraethoxysilane, γ-glycidochloropropylmethyl trimethoxysilane, vinyltriacetoxysilane, aminopropyl triethoxysilane, phenyltrimethoxysilane, and mixtures thereof. While not being bound by theory, it is believed that a silica precursor can have a rapid hydrolysis rate in the mixture and can also have a rapid condensation reaction rate on the substrate, when the treated substrates are dried or cured in an atmosphere containing ammonia gas. For example, the ammonia gas may be gas released from an aqueous ammonia.

Examples of water soluble catalysts may include nitric acid, hydrochloric acid, sulfuric acid, phosphoric acid, acetic acid, oxalic acid, citric acid, acrylic acid, polyacrylic acid, 1,2,3,4-butanetetracarboxylic acid, and mixtures thereof.

Examples of low-surface-energy compounds include alkoxysilanes, alkoxysiloxanes, fluoroalkyl alkoxysilanes, fluoroalkyl alkoxysiloxanes, and partly fluorinated vinyl polymers. One or more low-surface-energy compounds may be present in the form of a solution, an emulsion, a latex, a dispersion, or a suspension. Commercial products containing alkoxysilane, alkoxysiloxane, fluoroalkyl alkoxysilane, fluoroalkyl alkoxysiloxane, and/or partly fluorinated vinyl polymer may be used, such as fluorinated polymer emulsions from AGC Chemicals America, Inc., under the trademark of AG-710 and AG-480, and perfluoroalkyl acrylate emulsion from Daikin Industries, Ltd., under the trademark of Unidyne.

This method may provide a nano-structured surface having both surface roughness and low surface energy. The mixture applied to the substrate may provide a coating of low-surface-energy compounds on the rough structure of the surface.

The nano-structured surface may be easily accessible and have a durable self-cleaning effect. The silica precursors may preferably contain one or more alkoxy groups, such as ethoxy groups, as the reactive groups. The surface may be hydrophobic, and the agent for making the surface hydrophobic may be cross-linked and chemically bound to the substrate surface through reaction of surface-bound hydroxyl groups with these alkoxy groups. For example, the agent for making the surface hydrophobic may be 3-glycidoxypropyltrimethoxysilane.

### EXAMPLES

### Example 1

### Production of Cotton Fabrics with a Self-Cleaning Surface

A nano-structured surface was formed on a cotton fabric substrate. The substrate was treated with a mixture containing a silica precursor, a water-soluble catalyst and a low-surface-energy compound, and was then cured in the presence of ammonia. The silica precursor was methyltrimethoxysilane, the water-soluble catalyst was nitric acid, and the low-surface-energy compound was a fluoroalkyl alkoxysiloxane.

First, 2.5 ml of methyltrimethoxysilane was charged to 80 ml nitric acid solution (pH=2), and stirred for 10 minutes to hydrolyze the methyltrimethoxysilane. Fluoroalkyl alkoxysiloxane solution was prepared by dissolving 5 g of Dynasylan F8261, trademarked Sivento Silanes from Degussa, in 35 ml of ethanol. Then, 20 ml of fluoroalkyl alkoxysiloxane solution was introduced to the methyltrimethoxysilane solution to form a mixture, and stirred for 10 minutes at room temperature.

The plain cotton fabric substrate was treated by dipping it in the mixture for 1 minute, followed by pressing it with an automatic padder at a nip pressure of 2.75 kg/cm² and a rolling speed of 15 m/min, resulting in a wet pick-up of 75 weight percent. The wet cotton fabric substrate was suspended in a box filled with ammonia gas for 1 minute. Then, the cotton substrate was cured at 160° C. for 2 minutes.

The self-cleaning, or repellant, effect was evaluated by running drops of water down a slightly inclined surface, and the water contact angle was measured using a contact-angle meter (manufactured by Tantec in Schaumburg, Ill., U.S.A.). The contact angle on the surface was determined 60 seconds after the water drop was placed on the substrate. In this example, the water contact angle recorded by the contact-angle meter on this substrate was 149 degrees.

A scanning electron microscope photograph of the self-cleaning surface on the cotton fabric substrate is depicted in FIG. 1, and an optical image of a water droplet for measuring the water contact angle on the cotton fabric substrate is depicted in FIG. 2. FIG. 1 reveals that the water drops converged together, forming drying water beads. Given the small slope angle (13 degrees), those water beads slipped away easily from the substrate.

### Example 2

### Production of Cotton Fabrics with a Self-Cleaning Surface

A nano-structured surface was formed using the same method as described in Example 1, except that no silica precursor was present in the treatment mixture. The water contact angle recorded by the contact-angle meter on this substrate was 122 degrees. The lower contact angle relative to that of the surface of Example 1 was indicative of a lower surface energy for this surface. Thus, using methyltrimethoxysilane as a silica precursor enhanced the water contact-angle on the substrate relative to a surface prepared without the silica precursor.

### Example 3

### Production of Cotton Fabrics with a Self-Cleaning Surface

A nano-structured surface was formed using the same method as described in Example 1, except that the low-surface-energy compound was provided in a commercial product from AGC Chemicals American Inc. (e.g. nonionic, trademarked AG-710, with 30% solid content by weight). The water contact angle recorded by the contact-angle meter on this substrate was 156 degrees.

### Example 4

### Production of Polyester Fabrics with a Self-Cleaning Surface

A nano-structured surface was formed using the same method as described in Example 1, except that a polyester fabric was used as the substrate. The water contact angle recorded by the contact-angle meter on this substrate was 151 degrees. Thus, using a polyester fabric as the substrate enhanced the water contact-angle on the substrate relative to a cotton fabric treated with the same mixture.

### Example 5

### Production of a Wood Substrate Having a Self-Cleaning Surface

A nano-structured surface was formed using the same method as described in Example 1, except that a wood substrate was treated with the mixture by dipping it for 1 minute, followed by suspending it in a box filled with ammonia gas for 1 minute. Subsequently, the treated wood substrate was cured at 160° C. for 2 minutes. The water contact angle recorded by the contact-angle meter on this substrate was 162 degrees. Thus, using wood as substrate also enhanced the water contact-angle on the substrate relative to a cotton fabric treated with the same mixture.

While the examples of the nano-structured surface have been described, it should be understood that the composition is not so limited, and modifications may be made. The scope of the surface is defined by the appended claims, and all devices that come within the meaning of the claims, either literally or by equivalence, are intended to be embraced therein.

### REFERENCES

U.S. Pat. No. 3,354,022
U.S. Pat. No. 6,872,441
EP 0 772 514 B1
EP 0909 747 A1
EP 0 933 388 A2
DE application no. 100 16 485.4

What is claimed is:

1. A nano-structured surface, comprising:
a substrate layer; and
a plurality of immobilized nanoparticles on said substrate layer;
wherein said surface has a water contact angle of greater than 145 degrees.

2. The surface of claim 1, wherein said substrate is selected from the group consisting of fabric, leather, wood, glass, ceramic, concrete, plastic, metal, brick, and combinations thereof.

3. The surface of claim 2, wherein said fabric comprises fibres selected from the group consisting of cellulosic fibres, protein fibres, synthetic fibres, and combinations thereof.

4. The surface of claim 3, wherein said cellulosic fibres comprise cotton, linen, viscose, or combinations thereof.

5. The surface of claim 3, wherein said protein fibres comprise wool, silk, animal hair, or combinations thereof.

6. The surface of claim 3, wherein said synthetic fibres comprise polyester, polyamide, polypropylene, or combinations thereof.

7. The surface of claim 1, wherein said nanoparticles comprise silica nanoparticles.

8. The surface of claim 7, wherein said silica nanoparticles have a mean diameter from about 50 to 1000 nm.

9. The surface of claim 8, wherein said silica nanoparticles have a mean diameter from about 50 to 500 nm.

10. An in situ method of fabricating a nano-structured surface, comprising:
treating a substrate layer with a mixture that comprises a silica precursor, a water-soluble catalyst, and a low-surface-energy compound to form a treated substrate layer; and
curing said treated substrate layer in the presence of ammonia to form a nano-structured surface on said substrate layer;
wherein said surface has a water contact angle of greater than 145 degrees.

11. The method of claim 10, wherein said silica precursor is selected from the group consisting of methyltrimethoxysilane, methyltriethoxysilane, vinyltrimethoxysilicane, tetramethoxysilane, tetraethoxysilane, γ-glycidochloropropyl-methyl trimethoxysilane, vinyltriacetoxysilane, aminopropyl triethoxysilane, phenyltrimethoxysilane, and mixtures thereof.

12. The method of claim 10, wherein said water-soluble catalyst is selected from the group consisting of nitric acid, hydrochloric acid, sulfuric acid, phosphoric acid, acetic acid, oxalic acid, citric acid, acrylic acid, polyacrylic acid, 1,2,3,4-butanetetracarboxylic acid, and mixtures thereof.

13. The method of claim 10, wherein said low-surface-energy compound is selected from the group consisting of alkoxysilane, alkoxysiloxane, fluoroalkyl alkoxysilane, fluoroalkyl alkoxysiloxane, partly-fluorinated vinyl polymer, and mixtures thereof.

14. The method of claim 13, wherein said low-surface-energy compound is present in a form selected from the group consisting of a solution, an emulsion, a latex, a dispersion, and a suspension.

15. The method of claim 10, wherein said treated substrate layer is cured at a temperature from 60° C. to 180° C.

16. The method of claim 15, wherein said treated substrate layer is cured at a temperature from 60° C. to 120° C.

17. The method of claim 10, wherein said ammonia comprises gas released from an aqueous ammonia.

18. The method of claim 10, wherein said ammonia comprises gas released from the atmosphere.
